(19) United States
(12) Patent Application Publication
(10) Pub. No.: US 2021/0408536 A1
(43) Pub. Date: Dec. 30, 2021

(54) Electrode including a lithium-manganese-rich nickel, manganese, cobalt component and a lithium-iron-manganese phosphate component

(71) Applicant: GM GLOBAL TECHNOLOGY OPERATIONS LLC, Detroit, MI (US)

(72) Inventors: Meinan He, Madison Heights, MI (US); Jin Liu, Troy, MI (US); Xingcheng Xiao, Troy, MI (US); Mei Cai, Bloomfield Hills, MI (US)

(73) Assignee: GM GLOBAL TECHNOLOGY OPERATIONS LLC, Detroit, MI (US)

(21) Appl. No.: 16/911,986

(22) Filed: Jun. 25, 2020

(51) Int. Cl. H01M 4/525; H01M 4/505; H01M 10/0525; H01M 4/583; H01M 4/62

(52) U.S. Cl. CPC H01M 4/525; H01M 4/505; H01M 4/623; H01M 4/583; H01M 10/0525

(57) ABSTRACT

An electrode includes a domain material present in an amount of from about 90 to about 95 weight percent based on a total weight of the electrode. The domain material includes a component that has the formula: xLi₂MnO₃.(1−x)LiNiₐMn_{b}Co_{(1-a-b)}O₂, wherein x is greater than 0 and less than 1 and each of a and b is independently from about 0.1 to about 0.9 and the component is present in an amount of from about 50 to about 90 weight percent based on a total weight of the domain material. The domain material also includes an additive component having the formula LiFe_{1-y}Mn_{y}PO₄, wherein y is greater than 0 and less than 1, wherein the additive component is present in an amount of from about 10 to about 50 weight percent based on a total weight of the domain material. The electrode itself further includes a carbonaceous material and a binder.

### INTRODUCTION

The technical field generally relates to Li—Mn electrodes and more particularly relates to cathodes that include a Li-manganese-rich nickel, manganese, cobalt (LMRNMC) component and a Li—Fe—Mn—PO (LFMP) component.

Lithium batteries provide energy density by generating a discharge voltage typically of less than or equal to about 4.0 Volts. However, these batteries tend to suffer from limited cycle life, voltage fade, and limited rate capability. Moreover, at high voltages, typical electrolytes used in these batteries can decompose and limit the life of the battery. For example, parasitic reactions between electrodes and electrolyte tend to occur at high voltages and/or temperatures. This limits electrochemical performance.

As a result, Ni-rich compositions, such as NMC622 or NMC811 compositions, have been proposed for use in such lithium batteries. Although these compositions hold the promise of yielding cells with significant energy densities, issues associated with cycle-life have yet to be adequately addressed. For example, Ni-rich compositions, especially those beyond ˜60 wt % Ni, still face major challenges. In order to capitalize fully on the intrinsic energy content of such cathodes in terms of their high capacity and electrochemical potential (vs. Li/Li⁺), states of charge (SOCs) above the limits of lattice-oxygen stability are accessed. In this regard, the term ‘high-voltage’ may be defined for a particular LMRNMC composition based on this stability limit. For example, the evolution of oxygen from LMRNMC cathodes is triggered in the range about 4.3-4.7 V (vs. Li/Li⁺) for various compositions. Oxygen loss from the cathode surface can react with electrolyte and can also result in surface reconstruction, impedance rise, facile transition metal (TM) dissolution, and eventually loss of active lithium in the electrodes. Such intrinsic high-voltage limits are composition dependent and are mitigated or overcome if higher SOCs are to be used during the repeated cycling of a given LMRNMC composition. Moreover, these compositions tend to have low thermostability and are quite expensive, thereby limiting their applicability and use. These compositions also still have limited cycle life, still exhibit voltage fade, and have limited rate capability.

Alternatives are often denoted by two-component, ‘layered-layered’ (LL) notations. Some can deliver high capacities on repeated cycling. However, as with the LMRNMC compositions described above, oxygen sub-lattice instabilities also play a role. Specifically, for high-capacity components, an initial charge above about 4.4 V (Li/Li⁺) is needed to access high capacities through an activation process involving oxygen, which triggers structural transitions and the formation of disordered domains within the electrode. The activated structure continues to evolve with cycling thereby leading to the phenomena of voltage fade and hysteresis. The mechanisms governing the activation process, and hence the activated product, occur as a consequence of local structures within the pristine material in which some metals order preferentially to generate various arrangements within layers. The extent of ordering is related to the synthesis temperature and the amount of excess metals. As such, it can be shown that the magnitudes of several related phenomena (e.g., partially reversible cation migration, voltage fade, and hysteresis) scale with such amounts. In addition, low first-cycle efficiencies, poor rate capability, and high impedance at low SOCs have also been identified as limitations of some electrodes.

Accordingly, it is desirable to develop an electrode that has improved cycle life, reduced voltage fade, and increased rate capability. Furthermore, other desirable features and characteristics of the present disclosure will become apparent from the subsequent detailed description and the appended claims, taken in conjunction with the accompanying drawings and the foregoing technical field and background.

### SUMMARY

An electrode is provided for in this disclosure. In one embodiment, the electrode includes a domain material present in an amount of from about 90 to about 95 weight percent based on a total weight of the electrode. The domain material includes a Li-Manganese-rich nickel, manganese, cobalt component that has the formula: xLi₂MnO₃.(1−x)LiNiₐMn_{b}Co_{(1-a-b)}O₂, wherein x is greater than 0 and less than 1 and each of a and b is independently from about 0.1 to about 0.9 and the component is present in an amount of from about 50 to about 90 weight percent based on a total weight of the domain material. The domain material also includes an additive component having the formula LiFe_{1-y}Mn_{y}PO₄, wherein y is greater than 0 and less than 1, wherein the additive component is present in an amount of from about 10 to about 50 weight percent based on a total weight of the domain material. The electrode itself further includes a carbonaceous material and a binder, wherein the carbonaceous material and the binder are present in a combined amount of from about 5 to about 10 weight percent based on a total weight of the electrode.

In one embodiment, the electrode has a surface and further includes a coating disposed on the surface and/or the electrode includes the coating disposed on the domain material, wherein one or both coatings independently include SiO_{z}, CaF₂, AlF₃, Al₂O₃, AlPO₄, Co₃PO₄, zeolites, or combinations thereof, and wherein z is from greater than 0 and up to about 2.

In another embodiment, the electrode has a surface and further includes a coating disposed on the surface, wherein the coating includes SiO_{z}, CaF₂, AlF₃, Al₂O₃, AlPO₄, Co₃PO₄, zeolites, or combinations thereof, and wherein z is from greater than 0 and up to about 2.

In a further embodiment, the electrode further includes a coating disposed on the domain material, wherein the coating includes SiO_{z}, CaF₂, AlF₃, Al₂O₃, AlPO₄, Co₃PO₄, zeolites, carbon, lithium niobium oxide, lithium phosphate, lithium aluminate, lithium silicate, or combinations thereof, and wherein z is from greater than 0 and up to about 2.

In another embodiment, the Li-Manganese-rich nickel, manganese, cobalt component is present in an amount of from about 75 to about 85 weight percent based on a total weight of the domain material.

In another embodiment, the additive component is present in an amount of from about 15 to about 25 weight percent based on a total weight of the domain material.

In a further embodiment, the Li-Manganese-rich nickel, manganese, cobalt component is present in an amount of from about 75 to about 85 weight percent based on a total weight of the domain material and the additive component is present in an amount of from about 15 to about 25 weight percent based on a total weight of the domain material.

In a related embodiment, x is from about 0.25 to about 0.50, a is from about 0.35 to about 0.40, b is from about 0.35 to about 0.40, and y is from about 0.4 to about 0.6.

In another related embodiment, x is about 0.25, a is about 0.375, b is about 0.375, and y is from about 0.4 to about 0.6.

In still another related embodiment, the carbonaceous material is chosen from carbon black, carbon nanotubes, graphene, and combinations thereof and is present in an amount of from about 1.5 to about 2.5 weight percent based on a total weight of the electrode and wherein the binder is chosen from polyvinylidene fluoride, polytetrafluoroethylene, and combinations thereof and is present in an amount of from about 1.5 to about 2.5 weight percent based on a total weight of the electrode.

In another related embodiment, the domain material is doped with aluminum and/or magnesium in an amount of from about 1 to about 5 weight percent based on a total weight of the domain material.

In another embodiment, x is from about 0.25 to about 0.50, a is from about 0.35 to about 0.40, b is from about 0.35 to about 0.40, and y is from about 0.4 to about 0.6.

In a further embodiment, the electrode consists essentially of:
a domain material present in an amount of from about 90 to about 99 weight percent based on a total weight of the electrode and including:
   a Li-Manganese-rich nickel, manganese, cobalt component that has the formula: xLi₂MnO₃.(1−x)LiNiₐMn_{b}Co_{(1-a-b)}O₂, wherein x is greater than 0 and less than 1, each of a and b is independently from about 0.1 to about 0.9, and the component is present in an amount of from about 50 to about 90 weight percent based on a total weight of the domain material, and
   an additive component having the formula LiFe_{1-y}Mn_{y}PO₄, wherein y is greater than 0 and less than 1 and the additive component is present in an amount of from about 10 to about 50 weight percent based on a total weight of the domain material;

a carbonaceous material; and

a binder,

wherein the carbonaceous material and the binder are present in a combined amount of from about 1 to about 10 weight percent based on a total weight of the electrode, and

wherein the electrode has a loading range of from about 3 to about 5 mAh/cm².

In a related embodiment, the aforementioned electrode has a surface and further includes a coating disposed on the surface and/or the electrode includes the coating disposed on the domain material, wherein one or both coatings include AlF₃ and are present in a total amount of less than 1 weight percent based on a total weight of the electrode.

In another related embodiment, the Li-Manganese-rich nickel, manganese, cobalt component is present in an amount of from about 75 to about 85 weight percent based on a total weight of the domain material and the additive component is present in an amount of from about 15 to about 25 weight percent based on a total weight of the domain material.

In another related embodiment, x is from about 0.25 to about 0.50, a is from about 0.35 to about 0.40, b is from about 0.35 to about 0.40, and y is from about 0.4 to about 0.6.

In a further related embodiment, x is about 0.25, a is about 0.375, b is about 0.375, and y is from about 0.4 to about 0.6.

In another related embodiment, the carbonaceous material is chosen from carbon black, carbon nanotubes, graphene, and combinations thereof and is present in an amount of from about 1.5 to about 2.5 weight percent based on a total weight of the electrode and wherein the binder is chosen from polyvinylidene fluoride, polytetrafluoroethylene, and combinations thereof and is present in an amount of from about 1.5 to about 2.5 weight percent based on a total weight of the electrode.

In another related embodiment, the domain material is doped with aluminum and/or magnesium in an amount of from about 1 to about 5 weight percent based on a total weight of the domain material.

In another embodiment, the aforementioned electrode consists of the domain material, the carbonaceous material, the binder, and the coating.

### BRIEF DESCRIPTION OF THE DRAWINGS

The exemplary embodiments will hereinafter be described in conjunction with the following drawing figures, wherein like numerals denote like elements, and wherein:

FIG. 1A is a graph of dQ/dV (20) as a function of voltage vs. Li/Li⁺ (21) focusing on capacity vs. cycle number plots for a typical LMRNMC electrode of the art with the operation voltage between 2.5V and 4.45V, wherein A=cycle 1; B=cycle 2; C=cycle 50;

FIG. 1B is a graph of dQ/dV (22) as a function of voltage vs. Li/Li⁺ (24) focusing on capacity vs. cycle number plots for a typical LiNiMnCoO₂ oxide (NMC) electrode of the art with the operation voltage between 2.5V and 4.45V, wherein A=cycle 1; B=cycle 2; C=cycle 50;

FIG. 2 is an x-ray diffractogram of intensity (26) as a function of 2-Theta (28) confirming the identity of the Li-manganese-rich nickel, manganese, cobalt (LMRNMC) component 0.25Li₂MnO₃.0.75LiMn_{0.375}Ni_{0.375}Co_{0.25}O₂ of the examples wherein L: LLO, S: Spinel, and R: Rock Salt;

FIG. 3A is a graph of capacity (mAh/g) (30) as a function of cycle life (32) showing discharge capacity retention (D) and rate of electrochemical performance at 2.5-4.3V of the aforementioned LMRNMC component of the examples—Li_{1.15}Mn_{0.53125}Ni_{0.2815}Co_{0.187}O_{2.25} (3 mAh/cm²) having a high initial capacity of 180 mAh/g at 4.3V and a high normalized voltage of about 3.8V (NCM6223.7V);

FIG. 3B is a graph of normalized voltage (V) (34) as a function of cycle number (36) showing normalized voltage (V) as a function of cycle number and electrochemical performance (voltage fade/decay) of the aforementioned LMRNMC component of the examples—Li_{1.15}Mn_{0.53125}Ni_{0.2815}Co_{0.187}O_{2.25} (3 mAh/cm²) having a high initial capacity of 180 mAh/g at 4.3V and a high normalized voltage of about 3.8V (NCM6223.7V);

FIG. 3C is a graph of voltage (V) (38) as a function of capacity (mAh/g) (40) and electrochemical performance (voltage fade/decay (E) and activation (F)) of the aforementioned LMRNMC component of the examples—Li_{1.15}Mn_{0.53125}Ni_{0.2815}Co_{0.187}O_{2.25} (3 mAh/cm²) having a high initial capacity of 180 mAh/g at 4.3V and a high normalized voltage of about 3.8V (NCM622 3.7V);

FIG. 3D is a graph of capacity (mAh/g) (42) as a function of cycle number (44) showing capacity retention and rate of electrochemical performance at 2.5-4.45V of the aforementioned LMRNMC component of the examples—Li_{1.15}Mn_{0.53125}Ni_{0.2815}Co_{0.187}O_{2.25} (3 mAh/cm²) having a high initial capacity of 200 mAh/g at 4.3V and a high normalized voltage of about 3.85V (NCM622 3.8V);

FIG. 3E is a graph of normalized voltage (46) as a function of cycle number (48) showing electrochemical performance (voltage fade/decay) at 3.85-3.4V of the aforementioned LMRNMC component of the examples—Li_{1.15}Mn_{0.53125}Ni_{0.2815}Co_{0.187}O_{2.25} (3 mAh/cm²) having a high initial capacity of 200 mAh/g at 4.3V and a high normalized voltage of about 3.85V (NCM6223.8V);

FIG. 3F is a graph of voltage (V) (50) as a function of capacity (mAh/g) (52) and electrochemical performance (voltage fade/decay) of the aforementioned LMRNMC component of the examples—Li_{1.15}Mn_{0.53125}Ni_{0.2815}Co_{0.187}O_{2.25} (3 mAh/cm²) having a high initial capacity of 200 mAh/g at 4.3V and a high normalized voltage of about 3.85V (NCM6223.8V);

FIG. 4A is an x-ray diffractogram of intensity (54) as a function of 2-Theta (56) confirming the identity of the Lithium-Manganese-Iron-Phosphate (LMFP) additive component LiFe_{1-y}Mn_{y}PO₄, wherein y is about 0.4 to about 0.6 of the examples;

FIG. 4B is a graph of capacity (mAh/g) (58) as a function of cycle number (62) and mid-voltage (V)(H) showing capacity (G) retention of the aforementioned LMFP additive component;

FIG. 4C is a graph of voltage (V) (64) as a function of capacity (mAh/g) (66) at various rate/current (C) showing less voltage fade and a voltage plateau of the aforementioned LMFP additive component;

FIG. 5A is a graph of capacity (mAh/g) (68) as a function of cycle number (70) for the aforementioned LMFP additive component;

FIG. 5B is a graph of normalized voltage (V) (72) as a function of cycle number (74) for the aforementioned LMFP additive component, wherein FIGS. 5A/B show good cycle life, about 98% capacity retention for 500 cycles and stable high normalized voltage showing a drop from 4.0V to 3.88V within 500 cycles;

FIG. 6A is a graph of capacity (mAh/g) (76) as a function of cycle number (78) of two examples including 70% of the aforementioned LMRNMC component+30% of the aforementioned LMFP additive component at 4.45V (I) and 50% of the aforementioned LMRNMC component+50% of the aforementioned LMFP additive component (J), each at a 4.45V upper cutoff;

FIG. 6B is a graph of normalized voltage (V) (80) as a function of cycle number (82) of two examples including 70% of the aforementioned LMRNMC component++30% of the aforementioned LMFP additive component (K) and 50% of the aforementioned LMRNMC component+50% of the aforementioned LMFP additive component (M), each at a 4.45V upper cutoff;

FIG. 7A is a graph of normalized voltage (V) (84) as a function of cycle life (86) of 50% Li-rich NMC+50% LMFP electrode with a 20 μm thick zeolite coating (N), and a 50% Li-rich NMC+50% LMFP electrode without any coating (P); and

FIG. 7B is a graph of capacity (mAh/g) (88) as a function of cycle number (90) of the aforementioned 50% LMRNMC component+50% LMFP additive component electrode (Q) at 4.45V with a 20 μm thick zeolite coating (Q), and the aforementioned 50% LMRNMC component+50% LMFP additive component electrode without any coating (T) at 4.45V.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description.

In various embodiments, the present disclosure describes a new cathode design for extending cycle life, reducing cell cost, and improving fast charge capabilities of current EV batteries. In such embodiments, a low cost and high capacity Li-manganese-rich nickel, manganese, cobalt (LMRNMC) oxide composition is synthesized and selected as a dominant cathode material to replace a traditional Ni-rich nickel, manganese, cobalt (NMC) composition.

In addition, new strategies are described below to mitigate the typical voltage fade of LMRNMCs. A first strategy includes blending LMRNMC with a Lithium-Manganese-Iron-Phosphate (LMFP) additive component, which can have a 4V voltage plateau (Mn²⁺ to Mn³⁺) and can inhibit a side reaction of LMRNMC during operation above 4V. A second strategy includes applying a surface modification or coating on the electrode or active materials to form a kinetic barrier which can reduce or eliminate parasitic reactions between electrode and electrolyte during high voltage and temperature operation thereby resulting in improved electrochemical performance. In other embodiments, cycle life of Li rich based cathode cells can be improved, voltage fade problems of Li rich cathode can be addressed, costs of cathodes can be reduced, and rate capabilities can be improved. In still other embodiments, an approximately 87% capacity delivery can be observed at a 3C rate.

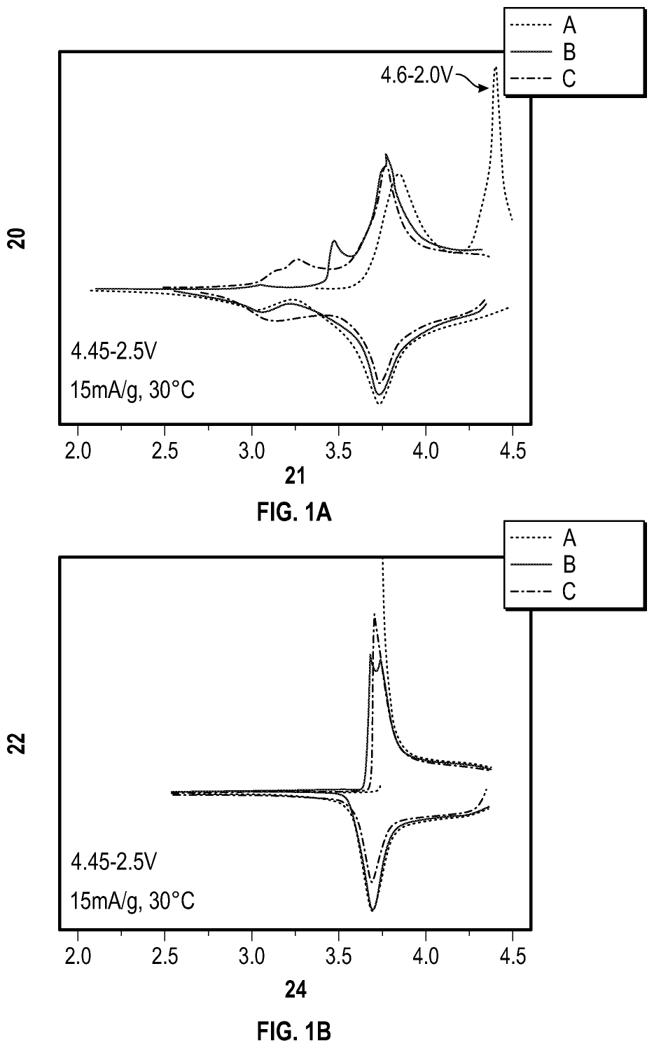

Lithium- and manganese-rich nickel manganese cobalt (LMRNMCs) oxide components can be denoted as two-component formulas such as xLi₂MnO₃.(1−x)LiNₐM_{b}C_{c}O₂. LMRNMCs have high capacities and can deliver (˜250 mAh/g) on repeated cycling based on different formulations. Moreover, the inclusion of large amounts of Mn provides good thermostability and low cost. However, an initial charge above ˜4.4 V (Li/Li+) is typically needed to access high capacities. Moreover, the activated structure continues to evolve with cycling thereby leading to the voltage fade and hysteresis. These phenomenon are shown in FIGS. 1A and 1B. FIG. 1A is a graph of dQ/dV (20) as a function of voltage vs. Li/Li⁺ (21) focusing on capacity vs. cycle number plots for a typical layered-layered spinel (LLS) electrode of the art with the operation voltage between 2.5V and 4.3V, wherein A=cycle 1; B=cycle 2; C=cycle 50. FIG. 1B is a graph of dQ/dV (22) as a function of voltage vs. Li/Li⁺ (24) focusing on capacity vs. cycle number plots for a typical LiNiMnCoO₂ oxide (NMC) electrode of the art with the operation voltage between 2.5V and 4.3V, wherein A=cycle 1; B=cycle 2; C=cycle 50.

Compared with a commercialized NMC cathode, LMRNMC shows higher initial capacity and normalize voltage so as energy density. However, with cycling, the LMRNMC shows voltage hysteresis and NMC shows better stability. The voltage hysteresis will lead to a fast energy density decay.

### Electrode:

In various embodiments, this disclosure provides an electrode that includes a domain material, a carbonaceous material, and a binder. It is contemplated that the electrode may be any type. In one embodiment, the electrode is further defined as a cathode. The electrode may be, include, consist essentially of, or consist of, the domain material, the carbonaceous material, and the binder. It is also contemplated that the electrode may be, include, consist essentially of, or consist of, the domain material, the carbonaceous material, the binder, and a coating and/or dopant, each of which is described in greater detail below. The terminology “consisting essentially of” describes various embodiments that are free of alternative domain materials that are not described herein, and/or carbonaceous materials that are not described herein, and/or binders that are not described herein and/or dopants that are not described herein, and/or coatings that are not described herein. It is also contemplated that the electrode may be free of any one or more of the specific components described below so long as the electrode still includes a domain material, a carbonaceous material, and a binder.

In various embodiments, the electrode has a loading range of from about 3 to about 5 mAh/cm². For example, the loading range may be about 3.5 to about 4.5, about 4 to about 4.5, or about 3, 3.5, 4, 4.5, or 5, mAh/cm². In various non-limiting embodiments, all values and ranges of values both whole and fractional including and between those described above, are hereby expressly contemplated for use herein. The porosity of the electrode is typically from about 20 to about 40, about 25 to about 35, or about 30 to about 35, %.

### Domain Material:

The domain material is present in the electrode in an amount of from about 90 to about 99 weight percent based on a total weight of the electrode. In various embodiments, the domain material is present in an amount of from about 91 to about 98, about 92 to about 97, about 93 to about 96, about 94 to about 95, about 90 to about 95, about 91 to about 94, about 92 to about 93, or about 91, 92, 93, 94, 95, 96, 97, 98, or 99, weight percent based on a total weight of the electrode. In various non-limiting embodiments, all values and ranges of values both whole and fractional including and between those described above, are hereby expressly contemplated for use herein.

The domain material can be, include, consist essentially of, or consist of, (1) a Li-manganese-rich nickel, manganese, cobalt (LMRNMC) component and (2) an additive component. The LMRNMC component may be further described as an oxide component. The LMRNMC component has the formula: xLi₂MnO₃.(1−x)LiNiₐMn_{b}Co_{(1-a-b)}O₂, wherein x is greater than 0 and less than 1, each of a and b is independently from about 0.1 to about 0.9. The (2) additive component that typically has a phospho-olivine structure and the formula LiFe_{1-y}Mn_{y}PO₄, wherein y is greater than 0 and less than 1. In various embodiments, the terminology “consists essentially of” describes that the domain material is free of components, or includes less than 10, 9, 8, 7, 6, 5, 4, 3, 2, 1, 0.5, or 0.1, weight percent of components based on a total weight of the domain material, that are not those described above.

The combination of the LMRNMC component and the additive component can form a layered-layered structure also described as an LL structure or a layered-layered-spinel structure also described as an LLS structure. These structures can be detected in the completed/unitary electrode using various analytical techniques including, but not limited to, x-ray diffraction, scanning electron microscopy, and the like. For example, TEM, XAS, ICP-MS or ICP-OES methods can be used. Moreover, typically, to form the electrode all of the components are mixed or otherwise combined using any method.

### LMRNMC Component:

Referring now to the LMRNMC component, this component is present in the domain material in an amount of from about 50 to about 90 weight percent based on a total weight of the domain material. In various embodiments, the LMRNMC component is present in an amount of from about 55 to about 85, about 60 to about 80, about 65 to about 75, about 70 to about 75, about 80 to about 90, about 80 to about 85, about 85 to about 90, or about 50, 55, 60, 65, 70, 75, 80, 85, or 90, weight percent based on a total weight of the domain material. In various non-limiting embodiments, all values and ranges of values both whole and fractional including and between those described above, are hereby expressly contemplated for use herein. The reason that electrode does not include more than about 90 weight percent of the LMRNMC component is because this component is combined with the additive component described in greater detail below which leads to the superior and unexpected results described in the Examples.

The LMRNMC component has the formula xLi₂MnO₃.(1−x)LiNiₐMn_{b}Co_{(1-a-b)}O₂, wherein x is greater than 0 and less than 1, each of a and b is independently from about 0.1 to about 0.9. It is contemplated that x can be any value that is greater than zero and less than 1. In various embodiments, x is from about 0.01 to about 0.99, about 0.05 to about 0.95, about 0.1 to about 0.9, about 0.15 to about 0.85, about 0.2 to about 0.8, about 0.25 to about 0.75, about 0.3 to about 0.7, about 0.35 to about 0.65, about 0.4 to about 0.6, about 0.45 to about 0.55, about 0.45 to about 0.5, about 0.5 to about 0.55, about 0.25 to about 0.75, about 0.25 to about 0.5, about 0.5 to about 0.75, or about 0.05, about 0.1, about 0.15, about 0.2, about 0.25, about 0.3, about 0.35, about 0.4, about 0.45, about 0.5, about 0.55, about 0.6, about 0.65, about 0.7, about 0.75, about 0.8, about 0.85, about 0.9, about 0.95, or about 0.99. In various non-limiting embodiments, all values and ranges of values both whole and fractional including and between those described above, are hereby expressly contemplated for use herein.

Moreover, each of a and b can independently be about 0.1 to about 0.9, about 0.15 to about 0.85, about 0.2 to about 0.8, about 0.25 to about 0.75, about 0.3 to about 0.7, about 0.35 to about 0.65, about 0.4 to about 0.6, about 0.45 to about 0.55, about 0.45 to about 0.5, about 0.5 to about 0.55, about 0.25 to about 0.75, about 0.25 to about 0.5, about 0.5 to about 0.75, or about 0.05, about 0.1, about 0.15, about 0.2, about 0.25, about 0.3, about 0.35, about 0.375, about 0.4, about 0.45, about 0.5, about 0.55, about 0.6, about 0.65, about 0.7, about 0.75, about 0.8, about 0.85, or about 0.9. In various non-limiting embodiments, all values and ranges of values both whole and fractional including and between those described above, are hereby expressly contemplated for use herein.

In one embodiment, the LMRNMC component has the formula 0.25Li₂MnO₃.0.75LiMn_{0.375}Ni_{0.375}Co_{0.25}O₂.

LMRNMC components can be synthesized according to any method of the art. In one embodiment, an LMRNMC component is synthesized according to the following formulae:

Na₂C₂O₄+0.53125MnSO₄+0.187CoSO₄+0.2815NiSO₄→

Mn_{0.53125}Ni_{0.2815}Co_{0.187}C₂O₄→

Mn_{0.53125}Ni_{0.2815}Co_{0.187}C₂O₄+Li₂CO₃→

Li_{1.15}Mn_{0.53125}Ni_{0.2815}Co_{0.187}O_{2.25}→

0.25Li₂MnO₃.0.75LiMn_{0.375}Ni_{0.375}Co_{0.25}O₂.

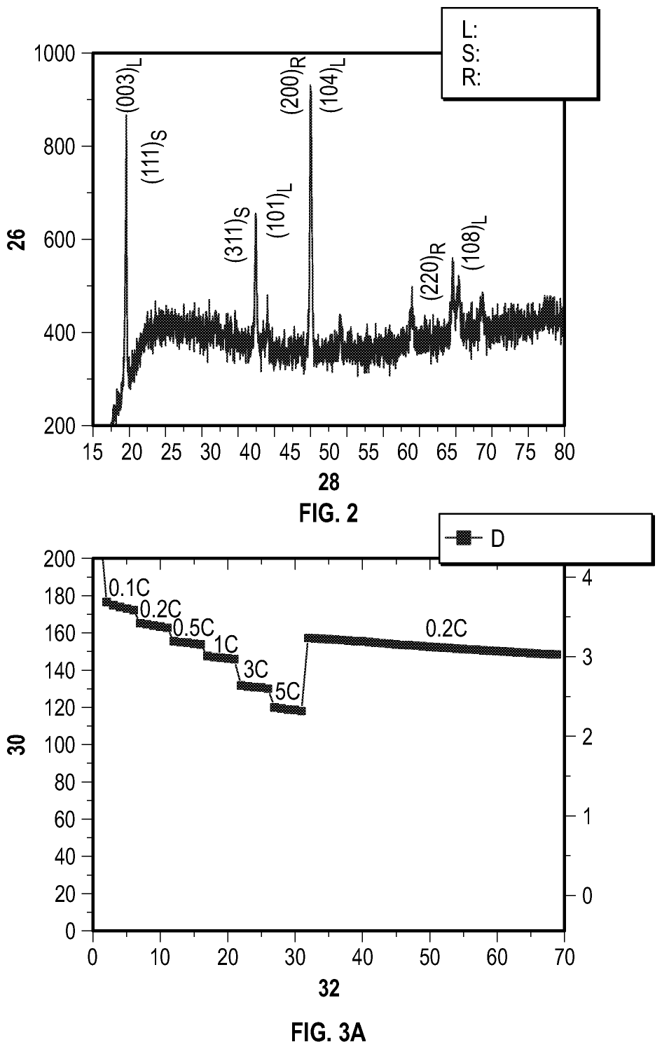

Synthesis of such LMRNMC components is further described in the Examples and can be confirmed by X-ray diffraction, e.g. as set forth in FIG. 2. FIG. 2 is an x-ray diffractogram of intensity (26) as a function of 2-Theta (28) confirming the identity of the Li-manganese-rich nickel, manganese, cobalt (LMRNMC) component 0.25Li₂MnO₃ 0.75LiMn_{0.375}Ni_{0.375}Co_{0.25}O₂ of the examples wherein L: LLO, S: Spinel, and R: Rock Salt.

### Additive Component:

Referring back, the additive component typically has a phospho-olivine structure. The mineral olivine is a magnesium iron silicate with the formula (Mg²⁺, Fe²⁺)₂SiO and is a type of nesosilicate or orthosilicate. The terminology phosphor-olivine means that the silicate is replaced with a phosphate (PO₄). Thus, the additive component of this disclosure has the formula LiFe_{1-y}Mn_{y}PO₄, wherein y is greater than 0 and less than 1.

It is contemplated that y can be any value that is greater than zero and up to less than about 1. In various embodiments, y is about 0.01 to about 0.99, about 0.05 to about 0.95, about 0.1 to about 0.9, about 0.15 to about 0.85, about 0.2 to about 0.8, about 0.25 to about 0.75, about 0.3 to about 0.7, about 0.35 to about 0.65, about 0.4 to about 0.6, about 0.45 to about 0.55, about 0.45 to about 0.5, about 0.5 to about 0.55, about 0.25 to about 0.75, about 0.25 to about 0.5, about 0.5 to about 0.75, or about 0.05, about 0.1, about 0.15, about 0.2, about 0.25, about 0.3, about 0.35, about 0.4, about 0.45, about 0.5, about 0.55, about 0.6, about 0.65, about 0.7, about 0.75, about 0.8, about 0.85, about 0.9, about 0.95, or about 0.99. In various non-limiting embodiments, all values and ranges of values both whole and fractional including and between those described above, are hereby expressly contemplated for use herein.

The additive component is present in the domain material an amount of from about 10 to about 50 weight percent based on a total weight of the domain material. Typically, this weight sums with the weight of the LMRNMC component to equal 100 wt % of the domain material. Notably, the domain material does not make up 100 wt % of the electrode as a whole. In various embodiments, the additive component is present in an amount of from about 15 to about 45, about 20 to about 40, about 25 to about 35, about 30 to about 35, about 10 to about 20, about 10 to about 15, about 15 to about 20, or about 10, 15, 20, 25, 30, 35, 40, 45, or 50, weight percent based on a total weight of the domain material. In various non-limiting embodiments, all values and ranges of values both whole and fractional including and between those described above, are hereby expressly contemplated for use herein.

In one embodiment, the LMRNMC component is present in an amount of from about 75 to about 85 weight percent based on a total weight of the domain material. In another embodiment, the additive component is present in an amount of from about 15 to about 25 weight percent based on a total weight of the domain material. In a further embodiment, the LMRNMC component is present in an amount of from about 75 to about 85 weight percent based on a total weight of the domain material and the additive component is present in an amount of from about 15 to about 25 weight percent based on a total weight of the domain material. In various non-limiting embodiments, all values and ranges of values both whole and fractional including and between those described above, are hereby expressly contemplated for use herein.

In still other embodiments, x is from about 0.25 to about 0.50, a is from about 0.35 to about 0.40, b is from about 0.35 to about 0.40, and y is from about 0.4 to about 0.6. In another embodiment, x is about 0.25, a is about 0.375, b is about 0.375, and y is from about 0.4 to about 0.6. In various non-limiting embodiments, all values and ranges of values both whole and fractional including and between those described above, are hereby expressly contemplated for use herein.

In another embodiment, the domain material is doped with aluminum and/or magnesium in an amount of from about 1 to about 5 weight percent based on a total weight of the domain material. The aluminum and/or magnesium may be any type, e.g. elemental aluminum and/or magnesium. Similarly, the amount of the dopant may be from about 1.5 to about 4.5, about 2 to about 4, about 2.5 to about 3.5, about 3 to about 4, or about 1, 1.5, 2, 2.5, 3, 3.5, 4, 4.5, or 5, weight percent based on a total weight of the domain material. The dopant may be added to the LMRNMC component, the additive component, or to both the LMRNMC component and the additive component. Alternatively, the dopant may be added to the domain material independent from the LMRNMC component and the additive component. In various non-limiting embodiments, all values and ranges of values both whole and fractional including and between those described above, are hereby expressly contemplated for use herein.

### Carbonaceous Material:

The electrode also includes the carbonaceous material. The carbonaceous material is not particularly limited and may be any type. In various embodiments, the carbonaceous material is chosen from carbon black, carbon nanotubes, graphene, and combinations thereof. Moreover, in various embodiments, the carbonaceous material is present in an amount of from about 0.1 to about 9.9, about 0.5 to about 9.5, about 1 to about 9, about 1.5 to about 8.5, about 2 to about 8, about 2.5 to about 7.5, about 3 to about 7, about 3.5 to about 6.5, about 4 to about 6, about 4.5 to about 5.5, about 4.5 to about 5, about 1.5 to about 2.5, or about 0.1, 0.5, 1, 1.5, 2, 2.5, 3, 3.5, 4, 4.5, 5, 5.5, 6, 6.5, 7, 7.5, 8, 8.5, 9, 9.5, or 9.9, weight percent based on a total weight of the electrode. In various non-limiting embodiments, all values and ranges of values both whole and fractional including and between those described above, are hereby expressly contemplated for use herein.

### Binder:

The electrode also includes the binder. The binder is not particularly limited and may be any type. In various embodiment, the binder is chosen from polyvinylidene fluoride, polytetrafluoroethylene, and combinations thereof. Moreover, in various embodiments, the binder is present in an amount of from about 0.1 to about 9.9, about 0.5 to about 9.5, about 1 to about 9, about 1.5 to about 8.5, about 2 to about 8, about 2.5 to about 7.5, about 3 to about 7, about 3.5 to about 6.5, about 4 to about 6, about 4.5 to about 5.5, about 4.5 to about 5, about 1.5 to about 2.5, or about 0.1, 0.5, 1, 1.5, 2, 2.5, 3, 3.5, 4, 4.5, 5, 5.5, 6, 6.5, 7, 7.5, 8, 8.5, 9, 9.5, or 9.9, weight percent based on a total weight of the electrode. In various non-limiting embodiments, all values and ranges of values both whole and fractional including and between those described above, are hereby expressly contemplated for use herein.

The weight percents of both the binder and the carbonaceous material are chosen such that the carbonaceous material and the binder are present in a combined amount of from about 1 to about 10 weight percent based on a total weight of the electrode. Moreover, in various embodiments, the combination of the carbonaceous material and the bind is present in an amount of from about 0.1 to about 9.9, about 0.5 to about 9.5, about 1 to about 9, about 1.5 to about 8.5, about 2 to about 8, about 2.5 to about 7.5, about 3 to about 7, about 3.5 to about 6.5, about 4 to about 6, about 4.5 to about 5.5, about 4.5 to about 5, about 1.5 to about 2.5, or about 0.1, 0.5, 1, 1.5, 2, 2.5, 3, 3.5, 4, 4.5, 5, 5.5, 6, 6.5, 7, 7.5, 8, 8.5, 9, 9.5, or 9.9, weight percent based on a total weight of the electrode. In various non-limiting embodiments, all values and ranges of values both whole and fractional including and between those described above, are hereby expressly contemplated for use herein.

In one embodiment, the carbonaceous material is chosen from carbon black, carbon nanotubes, graphene, and combinations thereof and is present in an amount of from about 1.5 to about 2.5 weight percent based on a total weight of the electrode. In the same embodiment, the binder is chosen from polyvinylidene fluoride, polytetrafluoroethylene, and combinations thereof and is present in an amount of from about 1.5 to about 2.5 weight percent based on a total weight of the electrode.

### Coating:

In various embodiments, the electrode has a surface and further includes a coating disposed on the surface and/or the electrode includes the coating disposed on the domain material. The terminology “disposed on” may describe that the coating is disposed on and in direct contact with the surface and/or the domain material or may describe that the coating is disposed on and separated from the surface and/or the domain material, e.g. if there is an intermediate layer disposed therebetween. It is also contemplated that the coating may be disposed on and in direct contact with the surface or the domain material and disposed on and separated from the other of the surface or the domain material.

The coating itself is not particularly limited and may be any type. In various embodiments, one or both of the aforementioned coatings may independently comprise SiO_{z}, CaF₂, AlF₃, Al₂O₃, AlPO₄, Co₃PO₄, zeolites, or combinations thereof, and wherein z is from greater than 0 and up to about 2. In other embodiments, one or both of the aforementioned coatings may independently comprise carbon, lithium niobium oxide, lithium phosphate, lithium aluminate, lithium silicate, or combinations thereof, In further embodiments, one or both of the aforementioned coatings may independently comprise SiO_{z}, CaF₂, AlF₃, Al₂O₃, AlPO₄, Co₃PO₄, zeolites, carbon, lithium niobium oxide, lithium phosphate, lithium aluminate, lithium silicate, or combinations thereof, wherein z is from greater than 0 and up to about 2. It is contemplated that z may be any value greater than zero and up to about 2, e.g. about 0.1 to about 2, about 0.5 to about 2, about 1 to about 2, about 1.5 to about 2, about 0.5 to about 1, about 0.5 to about 1.5, about 0.5 to about 1, about 0.5 to about 1.5, about 1 to about 1.5, or about 0.1, 0.5, 1, 1.5, or 2. In various non-limiting embodiments, all values and ranges of values both whole and fractional including and between those described above, are hereby expressly contemplated for use herein.

The coating may be applied or disposed on the surface and/or the domain material by any technique including, but not limited to, slurry coating, wet chemistry reaction, or vapor deposition. The vapor deposition may be further defined as chemical vapor deposition, physical vapor deposition, atomic layer deposition, or molecular vapor deposition, or combinations thereof.

Typically, if present, the coating will be present in an amount of less than about 1 weight percent based on a total weight of the electrode, e.g. 1, 0.5, 0.1, 0.05, or 0.01, weight percent. In various embodiments, the amount of coating disposed on the surface of the electrode is from about 18 mg/cm² to about 30 mg/cm², e.g. about 19 to about 29, about 20 to about 28, about 21 to about 27, about 22 to about 26, about 23 to about 24, or about 24 to about 25, mg/cm². In other embodiments, a thickness of the coating, e.g. single side coating thickness, is from about 20 to about 150, about 30 to about 140, about 40 to about 130, about 50 to about 120, about 60 to about 110, about 70 to about 100, about 80 to about 90, μm. In various non-limiting embodiments, all values and ranges of values both whole and fractional including and between those described above, are hereby expressly contemplated for use herein.

### Additional Embodiments

In other embodiments, the electrode consists essentially of, or consists of, the domain material present in an amount of from about 90 to about 99 weight percent based on a total weight of the electrode and including a Li-Manganese-rich nickel, manganese, cobalt component that has the formula: xLi₂MnO₃.(1−x)LiNiₐMn_{b}Co_{(1-a-b)}O₂, wherein x is greater than 0 and less than 1, each of a and b is independently from about 0.1 to about 0.9, and the component is present in an amount of from about 50 to about 90 weight percent based on a total weight of the domain material, and an additive component having the formula LiFe_{1-y}Mn_{y}PO₄, wherein y is greater than 0 and less than 1 and the additive component is present in an amount of from about 10 to about 50 weight percent based on a total weight of the domain material, a carbonaceous material, and a binder, wherein the carbonaceous material and the binder are present in a combined amount of from about 1 to about 10 weight percent based on a total weight of the electrode, and wherein the electrode has a loading range of from about 3 to about 5 mAh/cm². In such embodiments, the terminology “consists essentially of” describes that the electrode is free of, or includes less than 5, 4, 3, 2, 1, 0.5, or 0.1, weight percent based on a total weight percent of the electrode, of alternative domain materials that are not described herein, and/or carbonaceous materials that are not described herein, and/or binders that are not described herein. It is also contemplated that the electrode may be free of any one or more of the specific components described herein so long as the electrode still includes the required components of the claims.

In a related embodiment, the electrode has a surface and further includes a coating disposed on the surface and/or the electrode comprises the coating disposed on the domain material, wherein one or both coatings comprise AlF₃ and are present in a total amount of less than 1 weight percent based on a total weight of the electrode.

In another related embodiment, the LMRNMC component is present in an amount of from about 75 to about 85 weight percent based on a total weight of the domain material and the additive component is present in an amount of from about 15 to about 25 weight percent based on a total weight of the domain material.

In other related embodiments, x is from about 0.25 to about 0.50, a is from about 0.35 to about 0.40, b is from about 0.35 to about 0.40, and y is from about 0.4 to about 0.6. Alternatively, x is about 0.25, a is about 0.375, b is about 0.375, and y is from about 0.4 to about 0.6.

In other related embodiments, the carbonaceous material is chosen from carbon black, carbon nanotubes, graphene, and combinations thereof and is present in an amount of from about 1.5 to about 2.5 weight percent based on a total weight of the electrode and wherein the binder is chosen from polyvinylidene fluoride, polytetrafluoroethylene, and combinations thereof and is present in an amount of from about 1.5 to about 2.5 weight percent based on a total weight of the electrode.

In still other related embodiments, the domain material is doped with aluminum and/or magnesium in an amount of from about 1 to about 5 weight percent based on a total weight of the domain material.

This disclosure also provides a battery that includes the aforementioned electrode. The battery may be any type. This disclosure further provides a vehicle that includes that aforementioned battery and/or electrode. The vehicle is not particularly limited and may be any vehicle such as an automobile, plane, train, construction vehicle, ship, or the like.

### Examples

An LMRNMC component is synthesized according to the approximate following formulae:

Na₂C₂O₄+0.53125MnSO₄+0.187CoSO₄+0.2815NiSO₄→

Mn_{0.53125}Ni_{0.2815}Co_{0.187}C₂O₄→

Mn_{0.53125}Ni_{0.2815}Co_{0.187}C₂O₄+Li₂CO₃→

Li_{1.15}Mn_{0.53125}Ni_{0.2815}Co_{0.187}O_{2.25}→

0.25Li₂MnO₃.0.75LiMn_{0.375}Ni_{0.375}Co_{0.25}O₂.

An LMFP additive component is commercially purchased and has the formula LiFe_{1-y}Mn_{y}PO₄, wherein y is about 0.5.

After formation, a series of electrodes are formed:
Electrode 1: 100 wt % LMRNMC component=95 wt % of electrode;
   2.5 wt % carbon black (Super P); and
   2.5 wt % polyvinylidene fluoride (PVDF).
Electrode 2: 100 wt % LMFP additive component=95 wt % of electrode;
   2.5 wt % carbon black (Super P); and
   2.5 wt % polyvinylidene fluoride (PVDF).
Electrode 3: 70 wt % LMRNMC component+30 wt % LMFP additive component=95 wt % of electrode;
   2.5 wt % carbon black (Super P); and
   2.5 wt % polyvinylidene fluoride (PVDF).
Electrode 4: 50 wt % LMRNMC component+50 wt % LMFP additive component=95 wt % of electrode;
   2.5 wt % carbon black (Super P); and
   2.5 wt % polyvinylidene fluoride (PVDF).
   (No zeolite coating is disposed on the surface of the electrode.)
Electrode 5: 50 wt % LMRNMC component+50 wt % LMFP additive component=95 wt % of electrode;
   2.5 wt % carbon black (Super P);
   2.5 wt % polyvinylidene fluoride (PVDF); and
   20 μm thick zeolite coating disposed on surface of electrode.

The areal loading of each electrode was 3 mAh/cm² after calendaring to 25% porosity. The negative electrode is 450 μm Li chip purchased from MTI.

Electrolyte Preparation: Electrolytes were made with 1.2M Lithium hexafluorophosphate salt (LiPF₆) in Fluorinated Ethylene Carbonate/Ethyl methyl carbonate (FEC/EMC 1/4 in vol.). All of the salts and solvents were commercially purchased and further purified to battery electrolyte degree. The electrolyte preparation was performed in an Ar-filled glove box with controlled moisture content <2 ppm.

Coin cell preparation: 2032 typed coin cells were used for battery testing. Celgard® C210, microporous polypropylene/polyethylene/polypropylene (PP/PE/PP) was used as a separator. The effective diameters of the cathode, anode and separator were about 14 mm, 15 mm, and 16 mm, respectively. 40 μL of electrolyte was used for each coin cell.

The morphologies of the harvested electrodes were examined with scanning electron microscopy (SEM) using a Hitachi S-4800-II microscope.

### Analysis of Electrode 1:

The 100 wt % LMRNMC component of Electrode 1 was evaluated using x-ray diffraction to confirm its chemical identity. The results are set forth in FIG. 2 which is an x-ray diffractogram of intensity (26) as a function of 2-Theta (28) confirming the identity of the Li-manganese-rich nickel, manganese, cobalt (LMRNMC) component 0.25Li₂MnO₃ 0.75LiMn_{0.375}Ni_{0.375}Co_{0.25}O₂ of the examples wherein L: LLO, S: Spinel, and R: Rock Salt. The X-ray diffraction analyses were carried out by a Bruker D8 XRD with Cu target. The scan range is between 20 from 15 to 80 degree, with the scan rate of 2 degree/min.

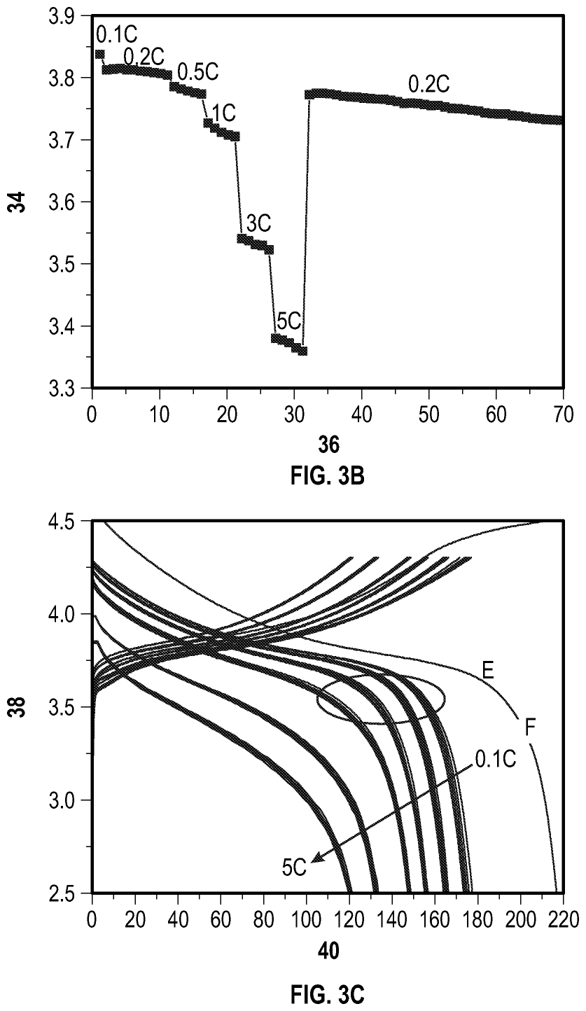

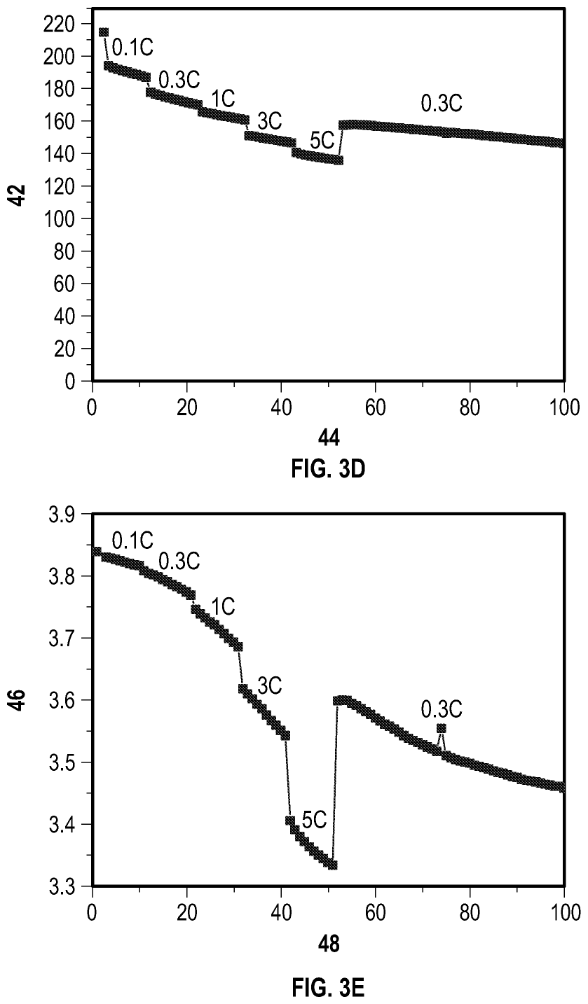

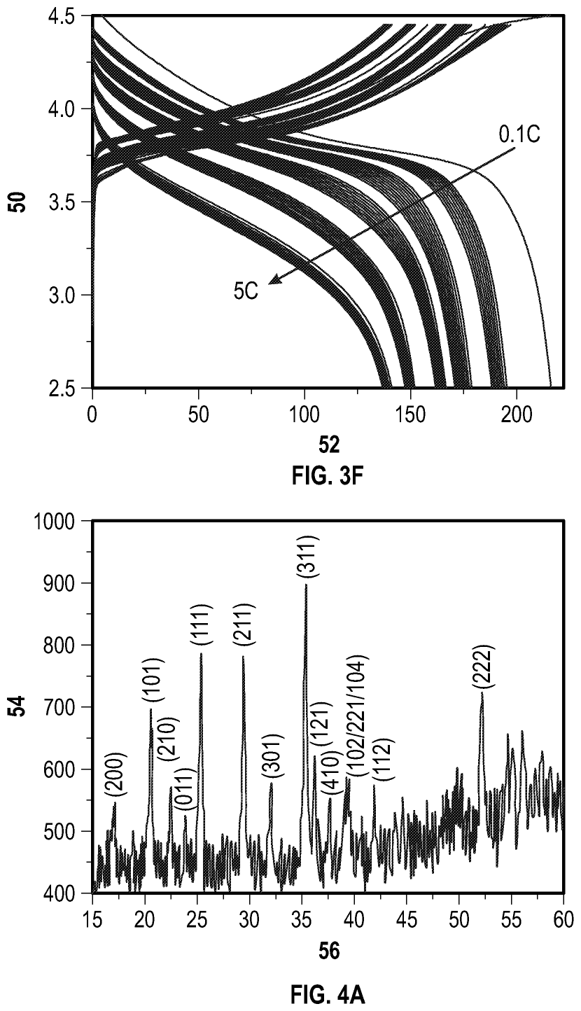

The 100 wt % LMRNMC component of Electrode 1 was also evaluated to determine capacity (mAh/g), cycle life, capacity retention, and rate of electrochemical performance at 2.5-4.3V. For these evaluations, Electrode 1 has a high initial capacity of 180 mAh/g at 4.3V and a high normalized voltage of about 3.8V (NCM6223.7V). The results are set forth in FIG. 3A. FIG. 3A is a graph of capacity (mAh/g) (30) as a function of cycle life (32) showing discharge capacity retention (D) and rate of electrochemical performance at 2.5-4.3V of the aforementioned LMRNMC component of the examples—Li_{1.15}Mn_{0.53125}Ni_{0.2815}Co_{0.187}O_{2.25} (3 mAh/cm²) having a high initial capacity of 180 mAh/g at 4.3V and a high normalized voltage of about 3.8V (NCM622 3.7V).

The 100 wt % LMRNMC component of Electrode 1 was also evaluated to determine capacity, cycle life, normalized voltage (V), cycle number, and electrochemical performance (voltage fade/decay) on a LAND cycler. For these evaluations, Electrode 1 has a high initial capacity of 180 mAh/g at 4.3V and a high normalized voltage of about 3.8V (NCM6223.7V). The results are set forth in FIG. 3B. FIG. 3B is a graph of normalized voltage (V) (34) as a function of cycle number (36) showing normalized voltage (V) as a function of cycle number and electrochemical performance (voltage fade/decay) of the aforementioned LMRNMC component of the examples—Li_{1.15}Mn_{0.53125}Ni_{0.2815}Co_{0.187}O_{2.25} (3 mAh/cm²) having a high initial capacity of 180 mAh/g at 4.3V and a high normalized voltage of about 3.8V (NCM6223.7V).

The 100 wt % LMRNMC component of Electrode 1 was also evaluated to determine voltage (V), capacity (mAh/g), and electrochemical performance (voltage fade/decay) on a LAND cycler. For these evaluations, Electrode 1 has a high initial capacity of 180 mAh/g at 4.3V and a high normalized voltage of about 3.8V (NCM6223.7V). The results are set forth in FIG. 3C. FIG. 3C is a graph of voltage (V) (38) as a function of capacity (mAh/g) (40) and electrochemical performance (voltage fade/decay (E) and activation (F)) of the aforementioned LMRNMC component of the examples—Li_{1.15}Mn_{0.53125}Ni_{0.2815}Co_{0.187}O_{2.25} (3 mAh/cm²) having a high initial capacity of 180 mAh/g at 4.3V and a high normalized voltage of about 3.8V (NCM6223.7V);

The 100 wt % LMRNMC component of Electrode 1 was also evaluated to determine capacity (mAh/g), cycle life, capacity retention, and rate of electrochemical performance at 2.5-4.45V on a LAND cycler. For these evaluations, Electrode 1 has a high initial capacity of 200 mAh/g at 4.3V and a high normalized voltage of about 3.85V (NCM6223.8V). The results are set forth in FIG. 3D. FIG. 3D is a graph of capacity (mAh/g) (42) as a function of cycle number (44) showing capacity retention and rate of electrochemical performance at 2.5-4.45V of the aforementioned LMRNMC component of the examples—Li_{1.15}Mn_{0.53125}Ni_{0.2815}Co_{0.187}O_{2.25} (3 mAh/cm²) having a high initial capacity of 200 mAh/g at 4.3V and a high normalized voltage of about 3.85V (NCM6223.8V).

The 100 wt % LMRNMC component of Electrode 1 was also evaluated to determine capacity, cycle life, nominalized voltage (V), cycle number, and electrochemical performance (voltage fade/decay) at 3.85-3.4V. For these evaluations, Electrode 1 has a high initial capacity of 200 mAh/g at 4.3V and a high normalized voltage of about 3.85V (NCM6223.8V). The results are set forth in FIG. 3E. FIG. 3E is a graph of normalized voltage (46) as a function of cycle number (48) showing electrochemical performance (voltage fade/decay) at 3.85-3.4V of the aforementioned LMRNMC component of the examples—Li_{1.15}Mn_{0.53125}Ni_{0.2815}Co_{0.187}O_{2.25} (3 mAh/cm²) having a high initial capacity of 200 mAh/g at 4.3V and a high normalized voltage of about 3.85V (NCM6223.8V).

The 100 wt % LMRNMC component of Electrode 1 was also evaluated to determine voltage (V), function of capacity (mAh/g), and electrochemical performance (voltage fade/decay). For these evaluations, Electrode 1 has a high initial capacity of 200 mAh/g at 4.3V and a high normalized voltage of about 3.85V (NCM6223.8V). The results are set forth in FIG. 3F. FIG. 3F is a graph of voltage (V) (50) as a function of capacity (mAh/g) (52) and electrochemical performance (voltage fade/decay) of the aforementioned LMRNMC component of the examples—Li_{1.15}Mn_{0.53125}Ni_{0.2815}Co_{0.187}O_{2.25} (3 mAh/cm²) having a high initial capacity of 200 mAh/g at 4.3V and a high normalized voltage of about 3.85V (NCM6223.8V).

FIG. 3A shows the rate performance and capacity retention of the as prepared electrode 1 under the operation voltage between 2.5V to 4.3. 180 mAh/g initial capacity and 67% 5C to 1C rate capacity retention was achieved. FIG. 3B shows the normalized voltage plot of the cell described in FIG. 3A. The normalized voltage decayed slightly during cycling, especially under high operation rate. FIG. 3C shows the voltage plot of that cell, the voltage plateau decay during cycling can also indicates the voltage fade.

FIG. 3D to F shows the capacity retention, normalized voltage and voltage plot of the cell with electrode 1 cathode under the operation voltage between 2.5V to 4.45V. The cell under higher cutoff voltage shows higher initial capacity, 200 mAh/g as well as high energy density. However, the high voltage operation triggers the peristatic reactions on the electrode surface, such as electrolyte decomposition, transition metal dissolution, the loss of O from lattice and crystal structure reconstruction. As the result, a severe voltage fade is observed under that high operation voltage window.

Components such as Li_{1.15}Mn_{0.53125}Ni_{0.2815}Co_{0.187}O_{2.25} (3 mAh/cm²) exhibit high initial capacity of about 180 mAh/g at 4.3V and high normalized voltage of about 3.8V (NCM6223.7V). However, such components suffer from voltage fade and surface side reactions resulting in/from the loss of transition metal and O and crystal structure reconstruction. Moreover, high current density high upper cutoff voltage operation, and high temperature operation will tend to accelerate the voltage fade. Moreover, components such as Li_{1.15}Mn_{0.53125}Ni_{0.2815}Co_{0.187}Oₓ can alternatively exhibit a high initial capacity of about 200 mAh/g at 4.45V and a high normalized voltage of about 3.85V (NCM6223.8V). However, again, such components tend to suffer from voltage fade triggered by high operation voltage. These aforementioned effects are shown in FIGS. 3A-3F.

### Analysis of Electrode 2:

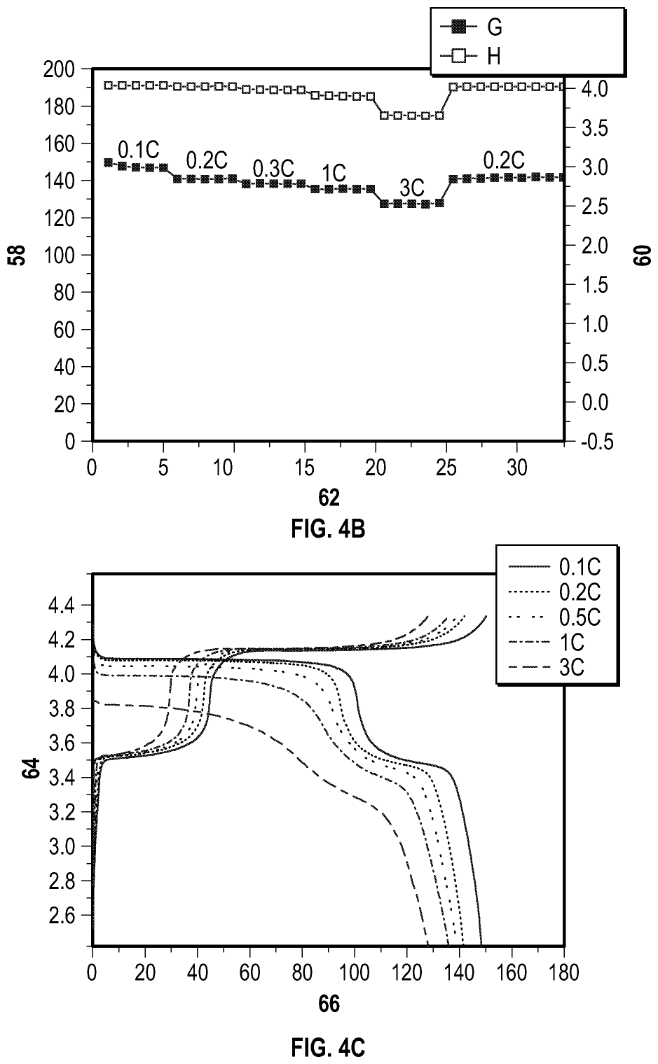

The 100 wt % LMFP additive component of Electrode 2 was evaluated using x-ray diffraction to confirm its chemical identity. The results are set forth in FIG. 4A. FIG. 4A is an x-ray diffractogram of intensity (54) as a function of 2-Theta (56) confirming the identity of the Lithium-Manganese-Iron-Phosphate (LMFP) additive component LiFe_{1-y}Mn_{y}PO₄, wherein y is about 0.4 to about 0.6 of the examples. The X-ray diffraction analyses were carried out by a Bruker D8 XRD with Cu target. The scan range is between 20 from 15 to 80 degree, with the scan rate of 2 degree/min.

The 100 wt % LMFP additive component of Electrode 2 was also evaluated to determine capacity (mAh/g), cycle number, and mid-voltage (V) thereby showing capacity retention. The results are set forth in FIG. 4B. FIG. 4B is a graph of capacity (mAh/g) (58) as a function of cycle number (62) and mid-voltage (V) (H) showing capacity (G) retention of the aforementioned LMFP additive component.

The 100 wt % LMFP additive component of Electrode 2 was also evaluated to determine voltage (V) and capacity (mAh/g) at various rate/currents (C) showing less voltage fade and a voltage plateau of the aforementioned LMFP as compared to Electrode 1. The results are set forth in FIG. 4C. FIG. 4C is a graph of voltage (V) (64) as a function of capacity (mAh/g)(66) at various rate/current (C) showing less voltage fade and a voltage plateau of the aforementioned LMFP additive component.

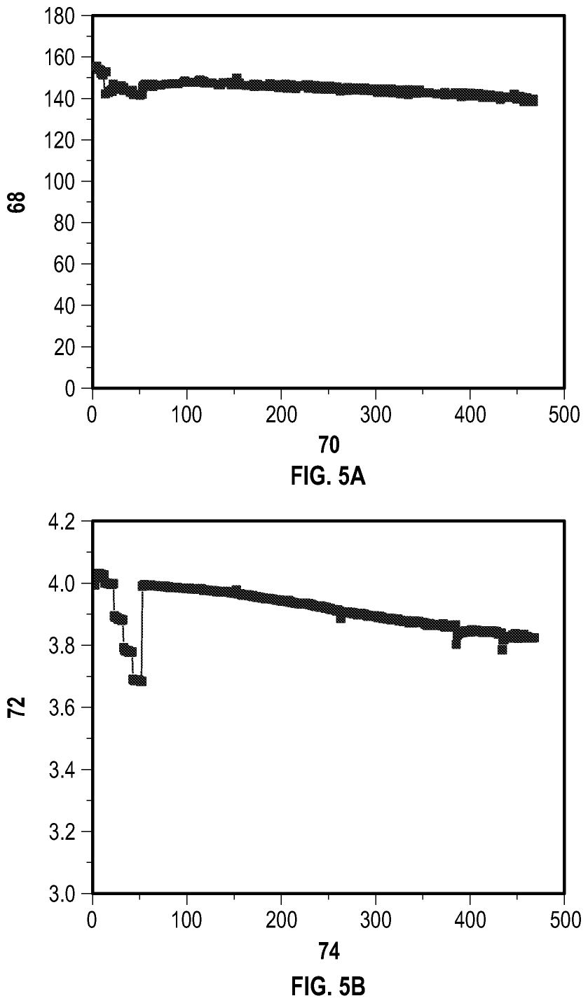

The 100 wt % LMFP additive component of Electrode 2 was also evaluated to determine capacity (mAh/g) (68) as a function of cycle number (70). The results are set forth in FIG. 5A.

The 100 wt % LMFP additive component of Electrode 2 was also evaluated to determine normalized voltage (V)(72) as a function of cycle number (74). The results are set forth in FIG. 5B.

FIGS. 5A/B show good cycle life, about 98% capacity retention for 500 cycles and stable high normalized voltage showing a drop from 4.0V to 3.88V within 500 cycles.

The LMFP shows an XRD pattern that matches its commercially proposed lattice structure. Based on the capacity retention and normalize voltage plot, Electrode 2 made using LMFP exhibits good capacity and voltage stability. As a result, it can be a good cathode additive candidate to mitigate the voltage fade caused by LMRNMC.

### Analysis of Electrodes 3 and 4:

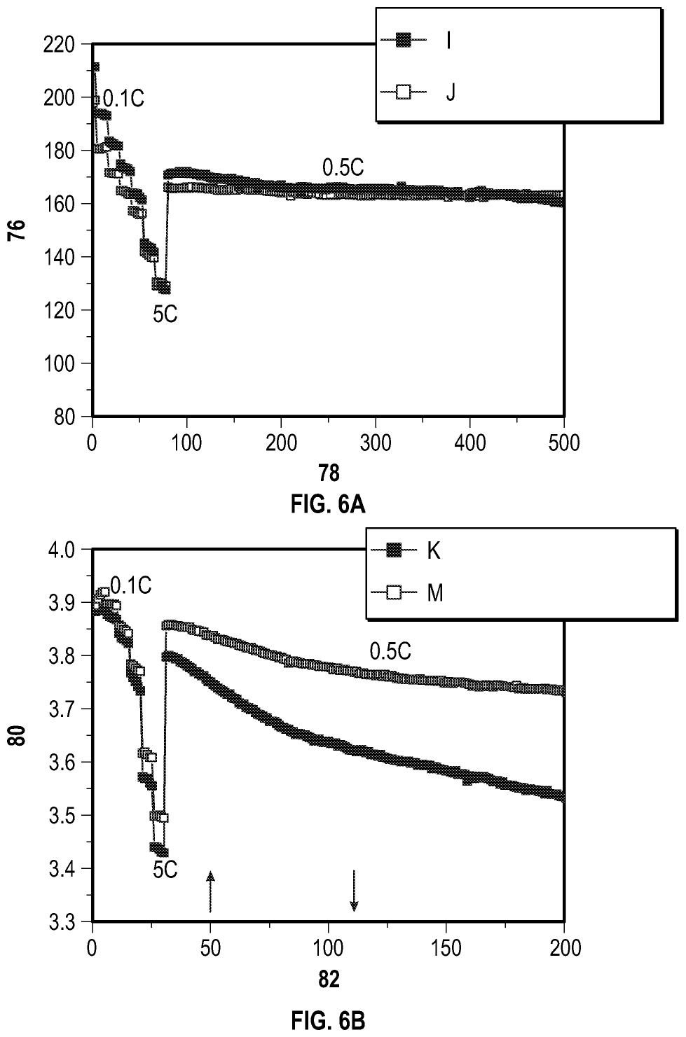

Electrodes 3 and 4 were evaluated to determine capacity (mAh/g) as a function of cycle number at 4.45V. The results are set forth in FIG. 6A. FIG. 6A is a graph of capacity (mAh/g) (76) as a function of cycle number (78) of two examples including 70% of the aforementioned LMRNMC component+30% of the aforementioned LMFP additive component at 4.45V (I) and 50% of the aforementioned LMRNMC component+50% of the aforementioned LMFP additive component (J), each at a 4.45V upper cutoff.

Electrodes 3 and 4 were also evaluated to determine normalized voltage (V) as a function of cycle number, each at a 4.45V upper cutoff. The results are set forth in FIG. 6B. FIG. 6B is a graph of normalized voltage (V) (80) as a function of cycle number (82) of two examples including 70% of the aforementioned LMRNMC component++30% of the aforementioned LMFP additive component (K) and 50% of the aforementioned LMRNMC component+50% of the aforementioned LMFP additive component (M), each at a 4.45V upper cutoff.

The aforementioned analyses demonstrate that the more LMPF that is added into the electrode, the better voltage and capacity stability during cycle can be reached.

### Analysis of Electrodes 4 and 5:

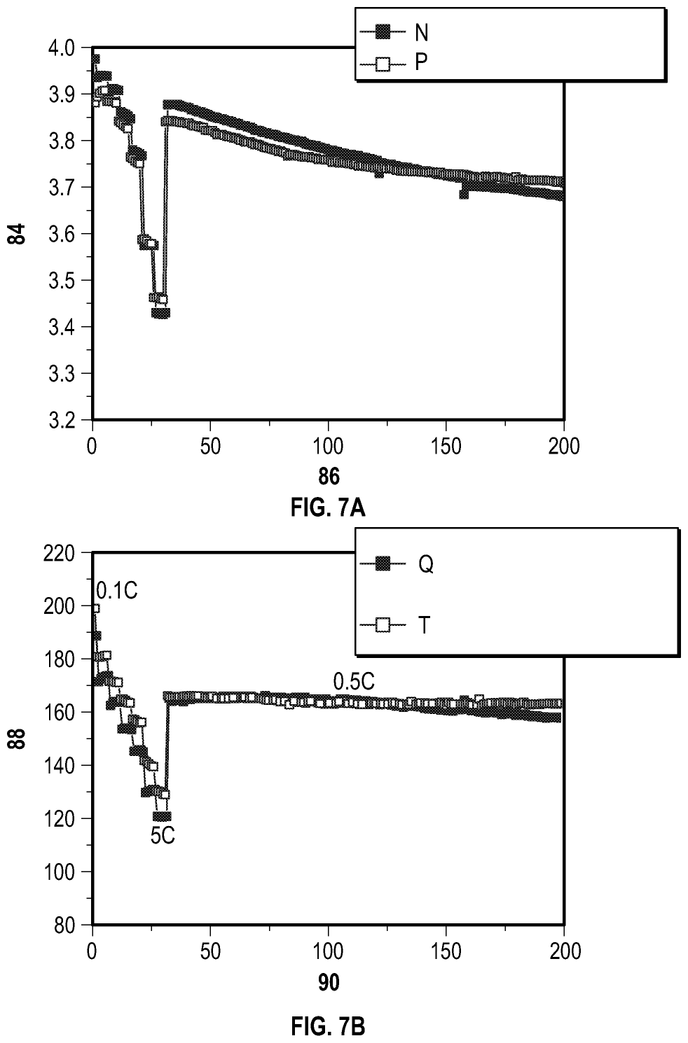

Electrodes 4 and 5 were evaluated to determine normalized voltage (V) as a function of cycle life thereby demonstrating the effect of the 20 μm thick zeolite coating on Electrode 5 as compared to the uncoated Electrode 4. The results are set forth in FIG. 7A. FIG. 7A is a graph of normalized voltage (V) (84) as a function of cycle life (86) of 50% Li-rich NMC+50% LMFP electrode with a 20 μm thick zeolite coating (N), and a 50% Li-rich NMC+50% LMFP electrode without any coating (P).

Electrodes 4 and 5 were also evaluated to determine capacity (mAh/g) as a function of cycle number at 4.45V. The results are set forth in FIG. 7B. FIG. 7B is a graph of capacity (mAh/g) (88) as a function of cycle number (90) of the aforementioned 50% LMRNMC component+50% LMFP additive component electrode (Q) at 4.45V with a 20 μm thick zeolite coating (Q), and the aforementioned 50% LMRNMC component+50% LMFP additive component electrode without any coating (T) at 4.45V.

The aforementioned analyses demonstrate that a usage of coating on the blended NMC/LMFP could help to improve and stabilize the cyclability of the electrodes.

While at least one exemplary embodiment has been presented in the foregoing detailed description, it should be appreciated that a vast number of variations exist. It should also be appreciated that the exemplary embodiment or exemplary embodiments are examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An electrode comprising:
a domain material present in an amount of from about 90 to about 99 weight percent based on a total weight of the electrode and comprising:
a Li-manganese-rich nickel, manganese, cobalt (LMRNMC) component that has the formula: xLi₂MnO₃.(1−x)LiNiₐMn_{b}Co_{(1-a-b)}O₂, wherein x is greater than 0 and less than 1, each of a and b is independently from about 0.1 to about 0.9, and the component is present in an amount of from about 50 to about 90 weight percent based on a total weight of the domain material, and
an additive component having the formula LiFe_{1-y}Mn_{y}PO₄, wherein y is greater than 0 and less than 1 and the additive component is present in an amount of from about 10 to about 50 weight percent based on a total weight of the domain material;
a carbonaceous material; and
a binder,
wherein the carbonaceous material and the binder are present in a combined amount of from about 1 to about 10 weight percent based on a total weight of the electrode.

2. The electrode of claim 1 wherein the electrode has a surface and further comprises a coating disposed on the surface and/or the electrode comprises the coating disposed on the domain material, wherein one or both coatings independently comprise SiO_{z}, CaF₂, AlF₃, Al₂O₃, AlPO₄, Co₃PO₄, zeolites, or combinations thereof, and wherein z is from greater than 0 and up to about 2.

3. The electrode of claim 1 wherein the electrode has a surface and further comprises a coating disposed on the surface, wherein the coating comprises SiO_{z}, CaF₂, AlF₃, Al₂O₃, AlPO₄, Co₃PO₄, zeolites, or combinations thereof, and wherein z is from greater than 0 and up to about 2.

4. The electrode of claim 1 wherein the electrode further comprises a coating disposed on the domain material, wherein the coating comprises SiO_{z}, CaF₂, AlF₃, Al₂O₃, AlPO₄, Co₃PO₄, zeolites, carbon, lithium niobium oxide, lithium phosphate, lithium aluminate, lithium silicate, or combinations thereof, and wherein z is from greater than 0 and up to about 2.

5. The electrode of claim 1 wherein the Li-Manganese-rich nickel, manganese, cobalt component is present in an amount of from about 75 to about 85 weight percent based on a total weight of the domain material.

6. The electrode of claim 1 wherein the additive component is present in an amount of from about 15 to about 25 weight percent based on a total weight of the domain material.

7. The electrode of claim 1 wherein the Li-Manganese-rich nickel, manganese, cobalt component is present in an amount of from about 75 to about 85 weight percent based on a total weight of the domain material and the additive component is present in an amount of from about 15 to about 25 weight percent based on a total weight of the domain material.

8. The electrode of claim 7 wherein x is from about 0.25 to about 0.50, a is from about 0.35 to about 0.40, b is from about 0.35 to about 0.40, and y is from about 0.4 to about 0.6.

9. The electrode of claim 7 wherein x is about 0.25, a is about 0.375, b is about 0.375, and y is from about 0.4 to about 0.6.

10. The electrode of claim 9 wherein the carbonaceous material is chosen from carbon black, carbon nanotubes, graphene, and combinations thereof and is present in an amount of from about 1.5 to about 2.5 weight percent based on a total weight of the electrode and wherein the binder is chosen from polyvinylidene fluoride, polytetrafluoroethylene, and combinations thereof and is present in an amount of from about 1.5 to about 2.5 weight percent based on a total weight of the electrode.

11. The electrode of claim 10 wherein the domain material is doped with aluminum and/or magnesium in an amount of from about 1 to about 5 weight percent based on a total weight of the domain material.

12. The electrode of claim 1 wherein x is from about 0.25 to about 0.50, a is from about 0.35 to about 0.40, b is from about 0.35 to about 0.40, and y is from about 0.4 to about 0.6.

13. An electrode consisting essentially of:
a domain material present in an amount of from about 90 to about 99 weight percent based on a total weight of the electrode and comprising:
a Li-Manganese-rich nickel, manganese, cobalt component that has the formula: xLi₂MnO₃.(1−x)LiNiₐMn_{b}Co_{(1-a-b)}O₂, wherein x is greater than 0 and less than 1, each of a and b is independently from about 0.1 to about 0.9, and the component is present in an amount of from about 50 to about 90 weight percent based on a total weight of the domain material, and
an additive component having the formula LiFe_{1-y}Mn_{y}PO₄, wherein y is greater than 0 and less than 1 and the additive component is present in an amount of from about 10 to about 50 weight percent based on a total weight of the domain material;
a carbonaceous material; and
a binder,
wherein the carbonaceous material and the binder are present in a combined amount of from about 1 to about 10 weight percent based on a total weight of the electrode, and
wherein the electrode has a loading range of from about 3 to about 5 mAh/cm².

14. The electrode of claim 13 wherein the electrode has a surface and further comprises a coating disposed on the surface and/or the electrode comprises the coating disposed on the domain material, wherein one or both coatings comprise AlF₃ and are present in a total amount of less than 1 weight percent based on a total weight of the electrode.

15. The electrode of claim 14 wherein the Li-Manganese-rich nickel, manganese, cobalt component is present in an amount of from about 75 to about 85 weight percent based on a total weight of the domain material and the additive component is present in an amount of from about 15 to about 25 weight percent based on a total weight of the domain material.

16. The electrode of claim 15 wherein x is from about 0.25 to about 0.50, a is from about 0.35 to about 0.40, b is from about 0.35 to about 0.40, and y is from about 0.4 to about 0.6.

17. The electrode of claim 15 wherein x is about 0.25, a is about 0.375, b is about 0.375, and y is from about 0.4 to about 0.6.

18. The electrode of claim 17 wherein the carbonaceous material is chosen from carbon black, carbon nanotubes, graphene, and combinations thereof and is present in an amount of from about 1.5 to about 2.5 weight percent based on a total weight of the electrode and wherein the binder is chosen from polyvinylidene fluoride, polytetrafluoroethylene, and combinations thereof and is present in an amount of from about 1.5 to about 2.5 weight percent based on a total weight of the electrode.

19. The electrode of claim 18 wherein the domain material is doped with aluminum and/or magnesium in an amount of from about 1 to about 5 weight percent based on a total weight of the domain material.

20. The electrode of claim 19 consisting of the domain material, the carbonaceous material, the binder, and the coating.
